(19) United States
(12) Patent Application Publication
(10) Pub. No.: US 2002/0022790 A1
(43) Pub. Date: Feb. 21, 2002

(54) Apparatus to reduce contraction during flexing of the knee

(76) Inventor: Jesus Calatayud Carral, Zaragoza (ES)

Correspondence Address: Evenson, McKeown, Edwards & Lenahan, P.L.L.C., 1200 G Street, N.W., Suite 700, Washington, DC, 20005, US

(21) Appl. No.: 09/863,464

(22) Filed: May 24, 2001

(30) Foreign Application Priority Data
Aug. 17, 2000 (ES) ES 200002092

(51) Int. Cl. A61H 23/00

(52) U.S. Cl. 601/107

(57) ABSTRACT

As apparatus reduces contracture during flexing of the knee and includes by a pusher and a tensioner. The pusher is made of an appropriate piece of material and shape to apply pressure to the upper part of the knee in the area corresponding to the end of the femur, with regulation of both the position of the piece and the pressure it exercises, preferably by way of a jack. The tensioner is formed by a part in the shape of a receptacle that holds onto the heel, and whose position and angle with respect to the axis of the leg can be regulated, Once the tensioner is in position, it can be moved longitudinally in the direction of separation from the pusher.

### BACKGROUND TO THE INVENTION

This application claims the priority of Spanish patent document 200002092, filed Aug. 17, 2000, the disclosure of which is expressly incorporated by reference herein.

The present invention reflects to an apparatus to reduce contracture during flexing of the knee, usable to achieve total extension of the leg, in order to avoid pathologies such as lumbagos, tendinitis, etc. caused by this deficit in the movement of the limb.

Contracture during flexing of the knee is a limitation of the movement of extension of the limb that causes the vertex of the same to be forward with respect to the vertical. This constructure forces muscles and tendons to work to maintain the extension of the leg which, it complete, would place the vertex of the same behind the vertical, maintained by the effect of gravity and the ends of the limb formed by the ligaments.

Where contracture exists, the additional efforts of the muscles and tendons, and the bad positioning of the knee, cause lumbalgias, tendinitis and other pathologies that should he avoided.

Today, no physiotherapeutic methods or mechanisms are known to correct contracture during flexing of the knee, and treatments are applied to associated pathologies and therefore there is no guarantee that they will not reappear after some time.

### SUMMARY OF THE INVENTION

Because of its form and use, the present invention provides a machine that when flexing the knee in a simple way, because it is configured to achieve the gradual elongation of the upper insertions of the gastroenemic muscle in the femoral condyles and the underlying portion of the rear capsule of the knee. Thereby, the vertex of the limb is behind the vertical when the leg is extended to avoid the above-described problems.

According to the present invention, the machine uses a pusher that acts against the front part of the leg, just above the knee, on the part corresponding to the lower end of the femur. A longitudinal tensioner of the heel is so placed that while pressuring the heel, it gives rise, in the form of movement of extension of the limb, to the pressure that the pusher exercises on the upper part of the knee.

The pusher is formed by a part of appropriate shape and texture to give a comfortable support against the leg, and its position can be regulated to adapt it to the different sizes and morphologies of the legs of different patients. Preferably, the support piece will be mounted on a swinging elongation, transversal to the axis of the leg, which can slide on the same to vary its position and also be blocked in a determined position. The swinging movement of the elongation will be caused preferably by a jack, and this movement is responsible for the pressure exerted on the knee.

The tensioner will preferably be made of a seating for the foot which holds the same at the heel, with its position being regulated both longitudinally, transversally and axially to adapt it to different persons. The longitudinal and transversal regulating movements are carried out preferably on pairs of perpendicular guides on which at least the longitudinal movement can be blocked when the tensioner has been positioned on the heel of the patient when the patient has his leg extended. Once this position is set, and using a screw spindle attached preferably to a lever, the tensioner is moved in the direction of separation from the pusher, pulling the leg and forcing the maximum extension of the limb, giving rise to the pressure exerted by the pusher.

### BRIEF DESCRIPTION OF THE DRAWINGS

Other objects, advantages and novel features of the present invention will become apparent from the following detailed description of the invention when considered in conjunction with the accompanying drawings.

FIG. 1 is a front, partial sectional view of the machine of the present invention; and

FIG. 2 is a detail of a plain view of the tensioner of the machine shown in FIG. 1,

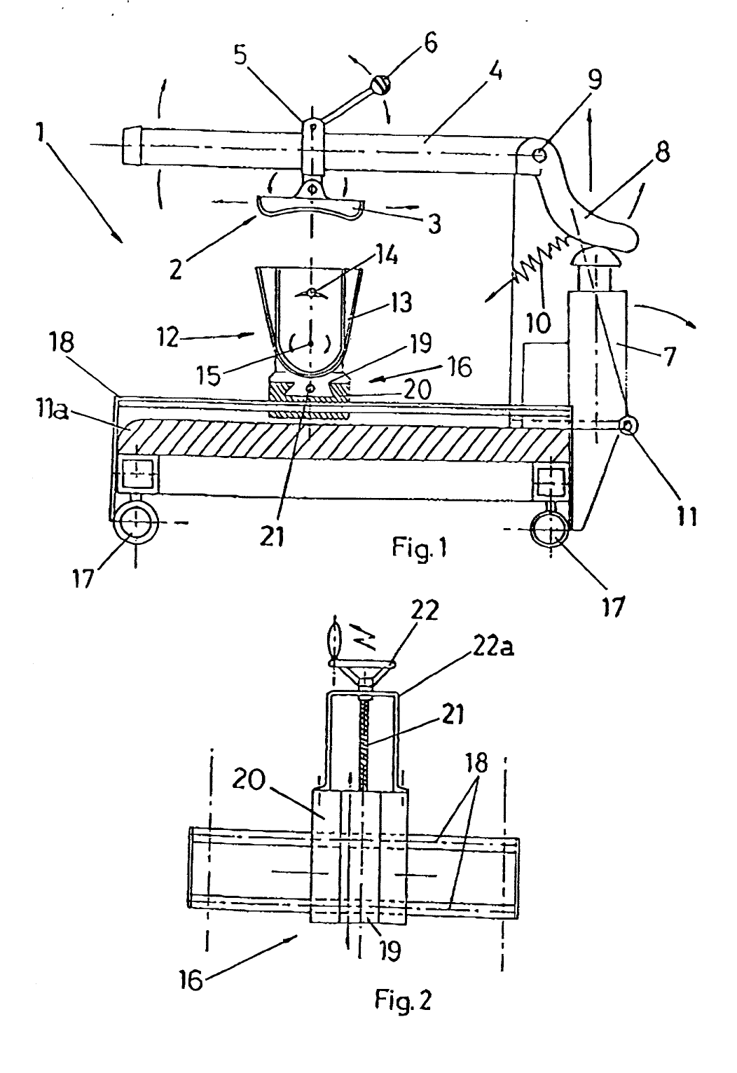

### DETAILED DESCRIPTION OF THE DRAWINGS

The machine designated generally by numeral 1 is formed by a pusher 2 made up of a lined curvo-concave piece 3 and mounted on a transversal elongation number 4 along which it can be moved and can be fixed in a desired position by an eccentric screw 5 activated by a lever 6.

By way of a jack 7, a prolongation 8 of the elongation member 4 is activated which makes the elongation 4 swing round an axis 9, exerting or reducing pressure on the knee, with a spring 10 aiding in the reduction. The elongation-spring-jack group swings round an axis 11 to facilitate the placing of the patient, who lies on a table 11

The tensioner 12 is formed by a support 13 that holds the foot, (not shown), having a turning movement limited by a stop 14 around the axis 15, to adapt it to various angles of the foot with respect to the axis of the leg. The support 13 is mounted on a structure 16 longitudinally and transversally moveable with respect to the leg, by way of pairs of perpendicular guides 17, 18. This allows the support 13 to be adapted to different morphologies and lengths of legs, and to block the longitudinal movement.

The structure 16 is formed by a part 19 attached to the support 13 that runs on another piece 20 that in turn slides on the guides 18 a coupling between parts 19, 20 is made by a dovetail that only allows longitudinal movements of one part on the other. This displacement is effected by a screw spindle 21 that screws onto the part 19 and which is activated by a lever 22 that rests on the part 20 by way of a support foot 22a.

In the foregoing manner, setting the longitudinal position of the support and activating the lever, the leg is pulled and the limb completely extended, and this combined with the pressure exercised by the pusher corrects the contracture when flexing the leg.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. Apparatus to reduce contracture when flexing a person's knee, comprising a pusher and a tensioner's wherein the pusher is configured as a part of appropriate material and shape, to press on an upper part of the knee, on an area corresponding to the end of the femur, where both a position of the part and an exertable pressure are regulatable; and the tensioner is configured as a part shaped as a receptacle to hold a person's heel, and whose position and angle with respect to an axis of a person's leg is regulated whereby the tensioner is positioned such that it is moveable in a longitudinal direction of separation from the pusher.

2. The apparatus according to claim 1, wherein at least one of a manually and electrically activated screw spindle is provided for moving the tensioners in the longitudinal direction.

3. The apparatus according to claim 1, wherein at least one of a hydraulic and pneumatic piston is provided for moving the tensioners in the longitudinal direction.

4. The apparatus according to claim 1, wherein the shape of the pusher is curvo-concave.

5. The apparatus according to claim 1, wherein the pusher is moveable mounted on a traverse elongation member.

6. The apparatus according to claim 1, wherein the pusher is swivellable to facilitate placement of the person's knee.

7. The apparatus according to claim 1, wherein the pusher is moveable via a jack device to exert or reduce pressure on the person's knee.
